(19) United States
(12) Patent Application Publication
(10) Pub. No.: US 2013/0204619 A1
(43) Pub. Date: Aug. 8, 2013

(54) SYSTEMS AND METHODS FOR VOICE-GUIDED OPERATIONS

(71) Applicant: Kextil, LLC, Pittsburgh, PA (US)

(72) Inventors: Jonathan R. Berman, Pittsburgh, PA (US); Jordan R. Cohen, Kure Beach, NC (US); Alexander I. Rudnicky, Pittsburgh, PA (US)

(73) Assignee: KEXTIL, LLC, Pittsburgh, PA (US)

(21) Appl. No.: 13/755,386

(22) Filed: Jan. 31, 2013

Related U.S. Application Data
(60) Provisional application No. 61/594,437, filed on Feb. 3, 2012.

(51) Int. Cl. G10L 21/10

(52) U.S. Cl. CPC G10L 21/10
USPC 704/235

(57) ABSTRACT

A method includes transforming textual material data into a multimodal data structure including a plurality of classes selected from the group consisting of output, procedural information, and contextual information to produce transformed textual data, storing the transformed textual data on a memory device, retrieving, in response to a user request via a multimodal interface, requested transformed textual data and presenting the retrieved transformed textual data to the user via the multimodal interface.

### CROSS-REFERENCE TO RELATED APPLICATIONS

This U.S. patent application claims the benefit of the following provisional application, which is incorporated herein by reference in its entirety: U.S. patent application 61/594,437 filed Feb. 3, 2012.

### BACKGROUND OF THE INVENTION

Field service operations, such as operations to install, maintain, or replace equipment, often involve complex, multi-step tasks that require access to data, decision-making, and logging of activities performed; however, current systems used to guide and record execution of such operations are limited, involving difficulty accessing background information (as such information is often buried in large manuals that do not differentiate between relevant and irrelevant information) and extensive paperwork or manual logging of data into fields of computer systems. As a result, compliance with operational guidelines is often poor, and logging of operational execution is often limited. These limitations make such operations error prone, and the lack of data about the choices made during failed operations makes it very difficult to improve future operations. Operational interfaces are also ineffective, as manual data entry systems, whether paper-based or computer-based, require users to stop what they are doing in order to access information or to log steps undertaken during execution of operations.

A need exists for methods and systems that improve access to relevant data, that effectively guide operational choices, and that effectively guide steps undertaken in the execution of operations, such as to enable the improvement of future operational guidelines. A need also exists for methods and systems for rendering existing materials more suitable for use in guiding operations, such as operations that can be undertaken with a voice-based interface.

### SUMMARY

Provided herein are methods and systems for organizing, guiding, and recording the execution of operations performed by personnel, such as field service personnel, using a voice interface.

Also provided herein are methods and systems for converting materials that govern operational procedures, such as field service manuals, into a form that is easily usable in a voice-guided execution of operations, including methods and systems for parsing operational information into different types, such that the information can be presented appropriately in the context of what is needed during execution of a particular operation.

The methods and systems disclosed herein may include methods and systems for providing a library of speech-based, optionally multimodal, operational subroutines designed for guidance of workers through field service and asset management operations.

The methods and systems disclosed herein may include methods and systems for providing speech-based subroutines that provide real time direction of workflows for field service and asset management operations.

The methods and systems disclosed herein may include methods and systems for providing an automated process and system to facilitate the conversion of existing field service or asset management documentation to a form that can be used in a speech-based workflow system.

The methods and systems disclosed herein may include methods and systems for providing a speech-based data log for capturing time-stamped events associated with a field service operation.

The methods and systems disclosed herein may include methods and systems for providing a speech-based data log for capturing events associated with a field service operation and assessing compliance with specified workflows.

The methods and systems disclosed herein may include methods and systems for providing a speech-based data log for capturing events associated with a field service operation with module for evaluating effectiveness of workflow.

The methods and systems disclosed herein may include methods and systems for providing a speech-based data log for capturing events associated with a field service operation with module for evaluating performance of individual performing work.

The methods and systems disclosed herein may include methods and systems for providing a workflow event management log for capturing worker path through specified workflows.

The methods and systems disclosed herein may include methods and systems for providing a workflow event management log for capturing path through workflows and comparing path durations of various paths.

The methods and systems disclosed herein may include methods and systems for providing a feedback module for providing feedback on speech-guided procedures.

The methods and systems disclosed herein may include methods and systems for providing a speech-based workflow management and logging software module for integration into enterprise service management system.

The methods and systems disclosed herein may include methods and systems for providing a speech-based workflow management and logging software module for integration into enterprise asset management system.

The methods and systems disclosed herein may include methods and systems for providing a speech recognition architecture with recognition layer, dialog layer and application layer for workflow management.

The methods and systems disclosed herein may include methods and systems for providing a speech-based workflow management and logging software module with mixed user- and system-initiated control.

The methods and systems disclosed herein may include methods and systems for providing an automated process and system to facilitate the conversion of existing field service or asset management documentation to a form that can be used in a speech-based workflow system, using separation of content into outputs, process steps and contextual information.

The methods and systems disclosed herein may include methods and systems for providing an analytic toolset, workbench or framework for analyzing data set containing log of time-stamped events associated with a speech-guided and/or speech-captured field service operation.

The methods and systems disclosed herein may include methods and systems for providing a software service facilitating software as a service-based access to an analytic toolset, workbench or framework for analyzing data set containing log of time-stamped events associated with a speech-guided and/or speech-captured field service operation.

The methods and systems disclosed herein may include methods and systems for providing a speech-based interface for searching a speech-enhanced workflow for information on a topic selected by a user.

The methods and systems disclosed herein may include methods and systems for creating a speech-based data log by capturing time-stamped events associated with a field service operation workflow.

The methods and systems disclosed herein may include methods and systems for creating a speech-based data log by capturing events associated with a field service operation and assessing compliance with specified workflows.

The methods and systems disclosed herein may include methods and systems for creating a speech-based data log by capturing events associated with a field service operation with module for evaluating effectiveness of workflow.

The methods and systems disclosed herein may include methods and systems for creating a speech-based data log by capturing events associated with a field service operation with module for evaluating performance of individual performing work.

The methods and systems disclosed herein may include methods and systems for creating a speech-based data log by capturing the worker path through specified workflows.

The methods and systems disclosed herein may include methods and systems for creating a speech-based data log by capturing the worker path through workflows and comparing path durations of various paths.

### BRIEF DESCRIPTION OF THE DRAWINGS

The invention and the following detailed description of certain embodiments thereof may be understood by reference to the following figures:

FIG. 1 depicts a system level diagram of the system in accordance with an exemplary and non-limiting embodiment.

FIG. 2 depicts additional details of the system of FIG. 1, including elements handled by a plan based dialog manager in accordance with an exemplary and non-limiting embodiment.

FIG. 3 depicts a start screen of display component of a multi-modal interface at which a user may commence executing a guided workflow in accordance with an exemplary and non-limiting embodiment.

FIG. 4 depicts a step of saving a workflow within the multimodal interface in accordance with an exemplary and non-limiting embodiment.

FIG. 5 depicts workflow configuration capabilities within the multimodal interface in accordance with an exemplary and non-limiting embodiment.

FIG. 6 depicts receiving a voice instruction to go to a step within a workflow within the multimodal interface in accordance with an exemplary and non-limiting embodiment.

FIG. 7 depicts handling a request for more detail within the multimodal interface in accordance with an exemplary and non-limiting embodiment.

FIG. 8 depicts continuing to a next step of a workflow within the multimodal interface in accordance with an exemplary and non-limiting embodiment.

FIG. 9 depicts completion of a step within a workflow within the multimodal interface in accordance with an exemplary and non-limiting embodiment.

FIG. 10 depicts entering data, a part number, within the multimodal interface in accordance with an exemplary and non-limiting embodiment.

FIG. 11 depicts selection from a pull-down menu within the multimodal interface in accordance with an exemplary and non-limiting embodiment.

FIG. 12 depicts taking entry via a keyboard within the multimodal interface in accordance with an exemplary and non-limiting embodiment.

FIG. 13 depicts capturing an action that was undertaken by a user during execution of workflow within the multimodal interface in accordance with an exemplary and non-limiting embodiment.

FIG. 14 depicts identifying a data field and capturing data during execution of a workflow within the multimodal interface in accordance with an exemplary and non-limiting embodiment.

FIG. 15 depicts presenting a message relating to compliance with requirements for a workflow within the multimodal interface in accordance with an exemplary and non-limiting embodiment.

FIG. 16 depicts logging time stamped data relating to steps completed within a workflow within the multimodal interface in accordance with an exemplary and non-limiting embodiment.

FIG. 17 depicts further details relating to logging time stamped data relating to steps completed within a workflow within the multimodal interface in accordance with an exemplary and non-limiting embodiment.

FIG. 18 depicts capture and paste capability within the multimodal interface in accordance with an exemplary and non-limiting embodiment.

FIG. 19 depicts troubleshooting capability within the multimodal interface in accordance with an exemplary and non-limiting embodiment.

FIG. 20 depicts identification of a problem with execution of a workflow within the multimodal interface in accordance with an exemplary and non-limiting embodiment.

FIG. 21 depicts performing a diagnostic test within the multimodal interface in accordance with an exemplary and non-limiting embodiment.

FIG. 22 depicts recording a diagnostic result within the multimodal interface in accordance with an exemplary and non-limiting embodiment.

FIG. 23 depicts performing a corrective action and recording a result within the multimodal interface in accordance with an exemplary and non-limiting embodiment.

FIG. 24 depicts further details relating to logging time stamped data relating to steps completed within a workflow within the multimodal interface in accordance with an exemplary and non-limiting embodiment.

### DESCRIPTION OF THE PREFERRED EMBODIMENTS

Various exemplary and non-limiting embodiments now be described in detail with reference to the accompanying drawings. As used herein, use of the term “embodiment” refers to exemplary and non-limiting embodiments and should not be construed as being limited to the illustrative embodiments set forth herein. Rather, the embodiments are provided so that this disclosure will be thorough and will fully convey the concept of the invention to those skilled in the art. The claims should be consulted to ascertain the true scope of the invention.

Provided herein are methods and systems that improve the applicability of spoken dialog systems to environments characterized by complex worker-system interaction. In particular, the methods and systems disclosed herein introduce spoken dialog systems to markets capable of extracting high value along three benefit dimensions: (a) improved customer satisfaction through compliance with best practices and faster worker ramp up to proficiency; (b) lower cost structure through the elimination of service event documentation time, a shorter time to resolution, and fewer repeat jobs; and (c) knowledge building through significantly more detailed service event reporting and workforce performance insight.

The present disclosure addresses the benefits of combining a true multi-modal interface with extremely robust plan-based dialog management capabilities in order to deliver the full set of benefits described herein. This disclosure also describes various performance characteristics of the application of such methods of systems in connection with operations related to medical equipment for the radiology industry.

As used herein, “textual material data” refers broadly to any and all data that may be comprised of elements forming an informational text including, but not limited to, words, graphics, embedded hypertext links and the like. In accordance with some exemplary and non-limiting embodiments described more fully below, textual material data may comprise preventive maintenance manual data and/or installation manual data.

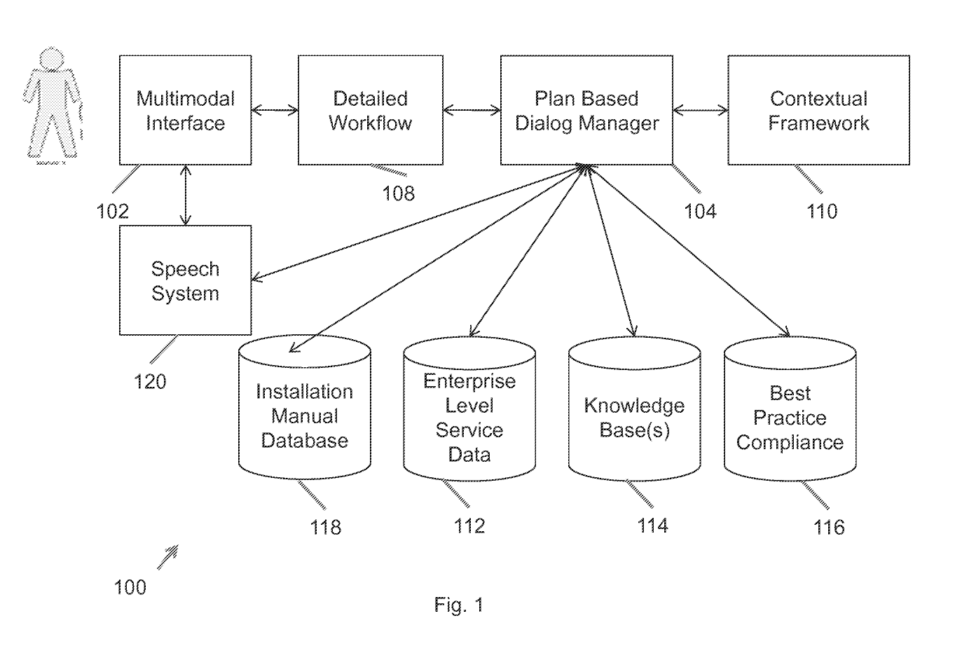

In accordance with an exemplary and non-limiting embodiments, two major components interact as part of a platform 100, with various other components and capabilities, to provide a set of benefits for complex work processes. Referring to FIG. 1, these are (a) a multimodal (i.e. input/output modes including screen, keyboard, and speech) user interface 102 and (b) a plan based dialog manager 104. The effective combination of these components provides for full functionality via both voice and keyboard/screen modes.

In accordance with an exemplary and non-limiting embodiments, the multimodal interface 102 may include a range of capabilities. During the course of a conventional service event, or multiple simultaneous service events, there is typically far too much information being captured, accessed, and acted upon for the user to store in unaided memory. In a speech only system, gaining access to any one item might be easy, but beyond that there are severe limitations. At the same time, a screen only interface is often very cumbersome for the user to access. The multimodal interface 102 enables the user to recall discrete pieces of information quickly via screen or voice, and more importantly provides a real time snapshot of the entire history of the workflow, current status, and a roadmap for future actions. A system that delivers this constantly updated context in real time enables the user to work in a highly optimal manner.

The dialog manager 104 acts as a conversational agent allowing the user and the software solution to stay on the same page. The dialog manager 104 improves the ability of the user and system to recover from errors, understand related inputs/outputs, or know whose turn it is to speak or listen. In the simplest terms, the dialog manager 104 handles the dynamic that would occur if two or more individuals were speaking to one another, i.e., it creates a context for understanding inputs and outputs.

From the user's perspective, the plan based dialog manager 104 allows for the collection of and access to information within the flow of the user's service work. Thus, the detailed workflow 108 can be managed by the dialog manager 104 and presented through the multimodal interface 102. A conventional system relying on just a recognizer or a form-filling dialog would only be able to capture disconnected pieces of information in separate events. This is a mismatch with the fundamental nature of field and remote service work, and it is within the flow of the service work that the optimal set of speed, accuracy, completeness, and convenience benefits can be realized. The current alternative using a screen based interface results in accessing and collecting information outside of the user's workflow, resulting in marked inefficiencies and many points for significant error.

At the intersection of the three major market demands is the ability to capture service workflow 108 as it is occurring without placing any additional burden on the service worker/user. Collecting this information at the host system level creates a dynamically changing context which enables the user to collect related information into enterprise level reporting tools and one or more knowledge bases. Establishing this context also enable system 100 to feed information back to the worker that significantly increases compliance with best service practices, data integrity, and data completeness.

Referring still to FIG. 1, the multimodal interface 102 may interact with and be supported by a speech system 120, which may take inputs from and deliver outputs to the multimodal interface 102 and the plan based dialog manager 104. Plan based dialog manager 104 may be implemented in software, in hardware or any combination of the two as discussed more fully below. Inputs may include speech from a user or other party, text, such as entered by a user or extracted from materials associated with a workflow, or the like. The speech system 120 may thus recognize speech input and/or synthesize speech output based on text or other inputs, such that speech can be used as one of the input and output modes of the multimodal interface 102. The speech system may be any of a wide variety of conventional speech recognition and speech synthesis systems, such as grammar-based systems, which in turn may use known types of language models. Speech synthesis systems may include a variety of such systems as known to those of ordinary skill in the art, including concatenative synthesis systems, including those using unit selection synthesis, diphone synthesis, or domain-specific synthesis, as well as formant synthesis systems, articulatory synthesis systems, HMM-based synthesis systems, and sinewave synthesis systems. Speech recognition systems may include those known to those ordinary skill in the art, including using structured languages, natural language models, statistical models, hidden Markov models, dynamic time warping (DTW)-based recognition, or other such techniques.

Referring still to FIG. 1 the plan based dialog manager 104 may operate in association with a contextual framework 110, which may determine the types of workflows 108 that are appropriate for a particular context, as well as indicate information sources relevant to those workflows, such as enterprise level service data 112, data from various knowledge bases 114, an installation manual database 118, and data relating to best practices 116. Enterprise level service data 112, data from various knowledge bases 114, an installation manual database 118, and data relating to best practices 116 may be stored, for example, in one or more databases accessible by plan based dialog manager 104.

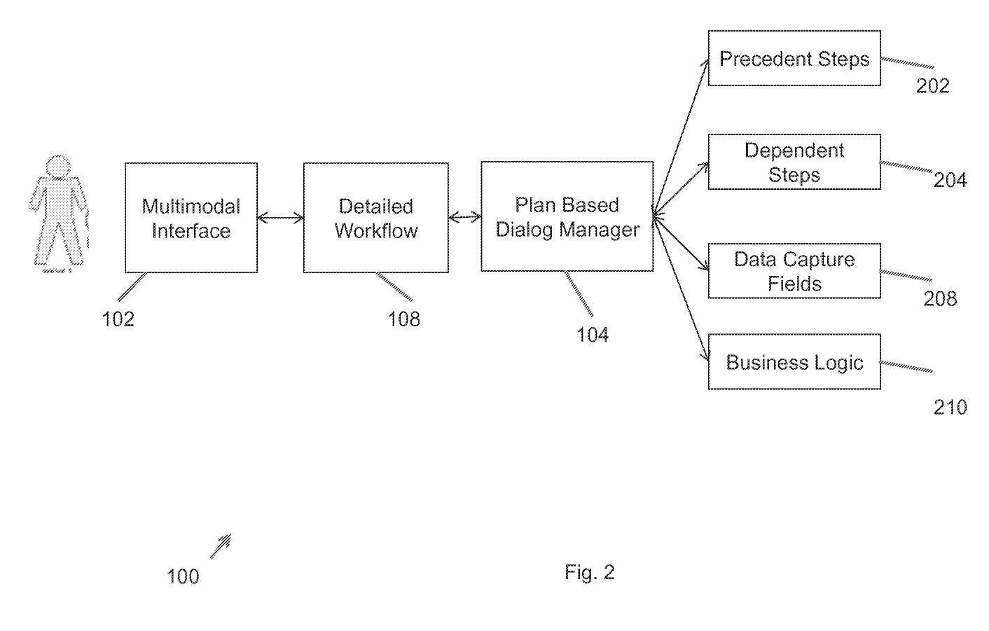

Referring to FIG. 2, the user can act on the new context in a myriad of ways per his discretion based on the insertion of business rules as may be stored, for example, in knowledge base 114. These may include the creation of precedent steps 202 and dependent steps 204 that guide a worker through a step-by-step set of interactions within a detailed workflow 108 in the correct order. These may also include business logic 210 that guides how a worker moves through the workflow 108, allowing decisions and conditional logic that move the worker through complex flows. Similarly, data capture fields 208 may be included, such as to allow recording of steps executed, parameters measured, problems identified or resolved, or a wide range of other factors. Thus, a highly structured workflow can be established in which the user is required to collect specific information at a given point and follow a prescribed path. Alternatively, an infinite branching system may be constructed, driven by the user, which may be used based on the user's discretion and experience. Moreover, the two extremes can be combined or alternated at any given point in the flow.

In embodiments, knowledge bases 114 can be populated with a previously unavailable granularity and volume of asset-related information with little or no incremental cost; service event documentation time is eliminated, freeing time for higher value additional service or customer relationship work; compliance with best practices increases; and workforce development needs are clarified. Each of these benefits has a direct connection to revenue generation or gross/net margin expansion of a business that uses the systems and methods described herein.

A plan based dialog manager 104 operates to make the methods and systems described herein work at the global enterprise level. Functionality including task independence, flexibility, transparency, modularity and reusability, and scalability align with enterprise requirements. Important in lowering total cost of ownership can be the combination of task independence and flexibility.

The reality of large organizations is that service documentation and practices are constantly evolving as products are updated and more experience is collected. Being able to separate that content and associated business practices from the framework solution is not afforded in conventional form filling approaches. In those instances, rules are often hard coded into structures that can become monolithic and difficult to change. In the presently disclosed methods and systems, updates can be conducted quickly, at minimal cost without extending an organization's document control processes, and performed by technical staff that does not have a background in speech based systems. As discussed in the framework above, global service organizations have a wide range of processes, workforce development needs, and knowledge demands that place a premium on system flexibility so that artificial constraints do not become a barrier to benefit maximization.

Other benefits enabled by the present methods and systems include (a) transparency: clear access to individual system components yields cost effective troubleshooting and optimization of the system; (b) modularity and reusability: across a global organization, there are many disparate service operations and processes though in many cases some of the workflow will be shared. A modular approach coupled with task independence allows for the quick reuse of developed software modules; and (c) scalability: a hierarchical plan based approach is well suited to deliver increasing value over time as the system is rolled out across geographies, business processes, and product lines; and can also accommodate increasingly complex system interaction. Moreover, these scalability characteristics are only of practical benefit to large organizations if the system is flexible enough to accommodate the on-going changes inherent in large organizations.

Thus, in the dynamic environment that defines global service organizations, only an advanced plan based dialog system is capable of achieving the lowest possible total cost of ownership.

In accordance with an exemplary and non-limiting embodiment, a system may be used to service medical equipment, such as for the radiology industry. In embodiments, the methods and systems allow a robust knowledge base can be significantly improved at the same time that the costs to construct such a base are markedly reduced. Also, the level of compliance with best practices can be markedly improved. The training and time required to move a worker to proficiency on a given service procedure can be dramatically reduced. Close to 100% of the time associated with service event reporting activities can be eliminated. From a functional standpoint, service technicians will benefit by being able to: collect required service reporting information during the service event; get assistance for any step in the relevant procedure; and conveniently access and act on all inputs for the relevant procedures.

By performing these tasks within the flow of their service work users are better positioned to achieve their key performance metrics and react to new management demands for greater levels of information capture. From the perspective of the business process owners, insight will take the form of detailed logs that document and time stamp discreet work flow steps in the order in which they were performed (without any reporting burden falling on service technician) and asset performance data and variables that highly inform the currently collected generic status information.

Information collected by the methods and systems disclosed herein may be stored and presented within a database structure that provides for quick query and analysis.

In embodiments, the methods and systems disclosed herein are built around advanced speech based human/computer interaction. The software enables users in a hands/eyes free manner to: capture information directly into back end data systems, gather highly detailed accounts of service events, and receive various forms of virtual supervision. This functionality set delivers three high ROI streams of value: efficiency, knowledge building, and compliance with best practices.

In accordance with an exemplary and non-limiting embodiment, an installation application or a field service application stores documents that describe the procedure and other information (multiple pieces) relating to the information, with the multimodal user interface 102 that allows navigation through the information in the documents either as a directed dialog, as a mixed-initiative dialog, or as a multimodal task which can be a combination of directed dialog and mixed initiative. The information is stored on a mobile computing platform used by the field service technician, or in networks or other memory devices available to him.

The system's capability to deliver these services all depend on capturing the original textual and graphical material associated with a conventional workflow application, and to transform it into a multimodal data structure used for directed dialog or freeform navigation interactions. While much of this work may be done manually, in certain embodiments conversion from conventional workflow is based on use of semantic and ontological resources that allow automation of the conversion. The final results of conversion of a workflow 108 allow speech, text, and click interfaces to the information using many platforms. The following example shows a before/after scenario for conversion of a detailed workflow 108 to a workflow 108 suitable for use with the dialog manager 104 and multimodal interface 102.

In an embodiment, a text-based workflow for a particular task, such as checking the quality of the color on the display of a personal computer, may include, for example, the following elements: “Inspect display: a. Connect PC to base; b. Press power switch to turn Display on. White screen with logo will appear briefly; c. verify display is clear and colors are correct. Note: May have to power down and up several times to see the complete screen.”

The methods and systems disclosed herein may organize the text and other material normally associated with a workflow into different classes of information, such as (a) output (e.g. “1. Inspect display”); (b) procedural information (e.g. substeps a.-c. in the example above); and (c) contextual information (e.g. “note: . . . May have . . . ; also pictures if applicable).” By parsing the information into types, whether manually or by semantic and/or ontological processing, the requirement is eliminated for all users to read or listen to the entire text related to a workflow or step thereof in order to glean the small amount of information that is actually relevant to that user's particular skill, experience level and situation. The presently disclosed methods and systems integrate with this multi-part information structure, enabling the user to interface with the content based on particular needs of a particular user within a particular situation. A user may thus receive just an output, information about a series of steps that lead to an output, or other content, such as procedural information, depending on the situation. This organization also allows for easy searches to access specific information, the linking of business logic/rules to very discrete steps, and detailed workflow tracking. These benefits combine to lower the cost and improve the quality of the service event.

Any organization that uses print materials, particularly those materials that are often updated (e.g. high tech, military, healthcare) will benefit from an automated transition of those materials to a structured format. The methods and systems disclosed herein may inform the development of modern text processing systems, which will automate or semi-automate the creation of structured material for multi-modal interactive systems like those described herein.

In embodiments, each deployment of the methods and systems disclosed herein guides a user, such as a field service person, through a procedure, while keeping extensive logs of the tasks completed, the timing of tasks, the information associated with each task, and ultimately a status for the entire procedure, including appropriate entries in a database, such as an enterprise level service database 112, such as the company's ERP system. In accordance with an exemplary and non-limiting embodiment, scripts and data may be produced which can interact with the ERP system or other systems associated with the business (CRM, knowledge base, post-install information, logging record system, etc.).

In embodiments, each process is keyed to a document or documents that describe the tasks to be accomplish, the information of use to the field service technician, a series of procedures or steps to accomplish the task, and a documentation phase.

In embodiments, methods and systems disclosed herein may follow a common architecture. This may include: (a) an application that runs on a technician's laptop (or other device, such as a smart phone or tablet computer) or a cloud based or server based computing facility and can display its own GUI; (b) speech input and output making use of the computer's standard input and output channels or an associated telephone channel; (c) a database that stores the installation manual; (d) an interface to an ERP and/or other systems for reporting purposes; and (e) different modes of speech recognition, including data capture, navigation and help.

In embodiments, a manual is available as a document for a detailed workflow 108. In some cases a computer-based manual is available as a segmented XML document. Manuals that are not structured may be segmented into steps and substeps, figures, tables, and other divisions. Steps and substeps may be linked to support information and navigation information, according to the architecture as described below. Manuals may be modified so that their spoken portions are clearly recognizable, and so that the system does not waste the time of the field service representative.

In embodiments, the entire application is multimodal. That is, it is possible to navigate to each element by pointing, by text input, or by speech input. In certain exemplary embodiments, steps may include: (a) number & title; (b) main body; (c) sub-step (optional); (d) sub-sub-step (optional); (e) (optional) reference to a figure; and/or (f) (optional) table.

The structure of the example installation manual may support the following functionality: (a) the system announces each step by its title; (b) depending on the amount of material the explanation is spoken/written or the user is asked if they want to hear/see it; and (c) the number of sub-steps may be announced. The application may have a multimodal interface 102, including speech, keyboard and pointer. The interface 102 handles the following categories of interaction.

In accordance with an exemplary and non-limiting embodiment, navigation is enabled for the user. For example, a user, such as a technician, can specify a jump to a different step by number or by name, in which cases steps may be identified in the multimodal interface 102 consistent with the status display for the steps. A user may jump to a different step, resume an original step sequence, identify steps by either name or number consistently with display, or even undertake and log procedures that are not currently documented.

In accordance with an exemplary and non-limiting embodiment, freeform navigation is allowed, in which a technician may specify the operation he/she is about to do, by name or number. Thus, name matching to a step may support inexact matching, and the system may respond with step or sub-step name and number, providing a display, audio or both. The system may support search throughout the entire procedure document and associated information.

In certain preferred embodiments, data input may be supported, such as allowing a user to enter data (alphanumeric or from a closed list) such as from spreadsheet, to accept digits or whole numbers, to accept alphanumeric strings, to accept entries from a list (potentially with the list displayed), to accept free or formatted text input, and to accept voice notes at any point in a workflow 108.

Guidance may be provided by the system throughout a workflow 108, such as to prompt user to perform next step (such as asking which step the user would like to do); to display a current status for the install, with the new step highlighted; to toggle a display as visible/hidden; to change a display to show sub steps; to query whether the technician wants guidance or not; to provide business logic feedback using business rules and user input or user query; and to provide implicit or explicit confirmation for any and all procedures.

A prompted checklist protocol may be followed to guide a user, in which a system may prompt a user for each checklist item and in turn listen for input, such as “OK”, “done”, “check”, or other spoken confirmation. The system may allow either step rerun, or troubleshooting. A checklist may allow “additional” steps added by the installer.

In embodiments, methods and systems disclosed herein may provide orientation information, such as allowing a user, such as a technician, to ask for an explanation; then resume a step sequence. For example, a technician can ask for an explanation of any step or sub-step (initially explanation means presenting and/or speaking the text description of the step). Also, a technician may be able to navigate to any step or sub-step by voice or keyboard. In embodiments, a technician can ask for a repeat of a step description, in which case a help function may return audio or visual cues for accomplishing a step. In embodiments the system may be able to query the operator for current status, such as to record the status at a point in the completion of the workflow 108.

In embodiments the user may request various information, such as to ask for display of a figure or a table. The user may query a table for explicit entries, including automatic cut-and-paste. A user may also ask for help, such as (“What can I do or say?”) or orientation (“What step are we on?”, “What's next?”). In embodiments, the system may ask the user what step he/she is currently on.

In embodiments the system displays information about the current step on a screen of the multimodal interface 102, such as system status if known and step-level information, including sub-steps if known. The display may allow for a minimized display, noting only step or sub-step number and title in a small box. A display progress indicator may be provided, such that the system tracks progress, and offers progress information toward workflow 108 completion on the display. In embodiments sub-step progress may be provided. A progress monitor may also provide navigation by keyboard and/or mouse. Time and progress tracking of procedures may available in the log and optionally to the user.

In embodiments the system may specify the input language and vocabulary, and grammatical constructions that the system is built to understand. These may include constructions related to help (“What can I do or say?”); orientation (“What step are we on?” “What's next?”); navigation by step number, name, section; inputs (numbers or digits, closed vocabulary items); discourse items (yes, no, etc); explanation—(how do I accomplish this step?); display figures/tables; and navigation with a slot to specify the location to which to go. In practice, language throughout the application may be tested for habitability, initially with the development team and subsequently with field technicians. The purpose of testing is to increase the learnability and habitability of the language. A grammar may be constructed, for use with the parser, to allow effective speech recognition.

Together with language specification, a speech recognition configuration may be created. The configuration may include acoustic models, lexical models and a language model. These may be generated from the grammar specification but later may interpolate speech and language observed in the field. The system may support both finite state and probabilistic grammars.

The system may further provide output language and speech synthesis, such as in English or other languages. Manual text may be designed for synthesis at the point of conversion of materials to the form appropriate for use with the dialog manager 104 and the multimodal display 102. This may include verifying that prompts and words are understandable and pronounced correctly. Orientation, state prompts, error prompts, and confirmation may be formulated by the design team for a particular workflow 108. Diagrams, figures and tables may be prepared for display (i.e. checked for readability and appropriateness).

In accordance with an exemplary and non-limiting embodiment, the plan based dialog manager 104 may set the context of input interpretation, identify which prompts to output and manage the overall flow of the interaction of the user with a workflow 108. Much of its functionality is described in the above. The dialog manager 104 may handle interaction with the display component of the multimodal interface 102 (as GUI inputs can affect system state). The architecture of one embodiment of the dialog manager 104 is described below.

The dialog manager 104 may include the business logic module 210 and/or domain reasoner that manages data collection and enforces rules such as preserving partial ordering of steps and detecting inconsistencies. Depending on need it may also cause the system to ask the technician to provide additional commentary on the installation or deployment of a workflow 108.

The business logic module 210 manages the interaction, with the ERP back-end system, such as a field service database 112, such as by checking correctness of data, filling in known information and communicating with the ERP back-end. It also handles errors at this interface (e.g. by notifying the technician about problems).

The business logic module 210 may also contain the interface to the installation manual database 118. That is, it may handle dialog manager requests for particular texts and figures.

In accordance with an exemplary and non-limiting embodiment, the system may be integrated with enterprise level databases, such as enterprise level service databases 112, or more general ERP databases. The system may upload information about the installation to an ERP or other database, either during the procedure or after finishing a task. The ERP interface may be either interactive or one-way, with format checking done by both the host system and the ERP system.

Data logging may be provided for the workflow 108. The methods and systems may be instrumented to capture step progression and time-stamp information, so that the same can later be uploaded to an ERP system, such as a Seibel system or used for analysis by the customer. The dialog system may log all speech, decodings, prompts and other information that can be used to analyze system performance (e.g. for maintenance and development). Logged data may be stored on the computer, using a logical organization (e.g., folders indexed by date, session, etc.) with speech and log files. Simple log analysis tools may be provided (e.g., step order, time per step, etc.).

In embodiments, the hardware platform may be a laptop, such as a technician's laptop, typically Windows 7 or the latest system, or cloud based or server based or telephone based platform, such as a mobile phone platform. The software of the present systems may be designed to have minimal impact to other procedures running on the technician's computer. In embodiments the application may be distributed with a specific headset (speech recognition being tuned to the characteristic of this device). For example, a Bluetooth headset will be used (as to not hinder technician movement).

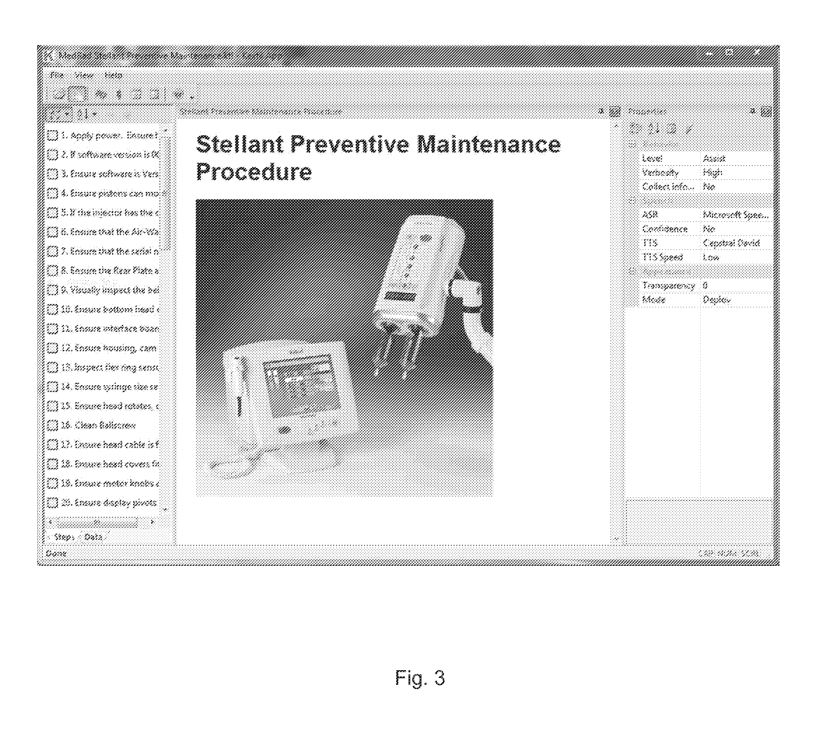

Further details of the methods and systems disclosed herein may be understood by reference to an example workflow, some steps of which are depicted in FIGS. 3 through 24. It should be understood that the multimodal interface 102 may allow a user to interact via voice, touch, or keyboard input, such that the visual display depicted in FIGS. 3 through 24 is typically accompanied by an audio component that includes speech and other sounds synthesized within the speech system 120 of the platform 100 as well as speech uttered by the user and captured through the multimodal input 102 for use by the speech system 120. It should also be understood that multiple, simultaneous workflows may be undertaken under the control of the host system, including by a single user. Thus, a user may pause one workflow, such as while waiting for an item being worked on to respond, or the like, and initiate another workflow, such as related to another piece of equipment. The worker may then return to the paused workflow and recommence it, picking up where the initial workflow left off at the point that it was paused.

FIG. 3 depicts a start screen of display component of a multi-modal interface of the present disclosure, at which a user may commence executing a guided workflow according to the present disclosure, in this case a procedure for preventive maintenance on a medical device. The main name for the workflow is depicted with a graphical representation that may help a user confirm it is the correct procedure. A list of the steps involved in the workflow is included in a separate window (in this case to the left of a screen), such that a user may see the upcoming steps and optionally navigate to a particular step by either clicking on that step or using speech to navigate to that step.

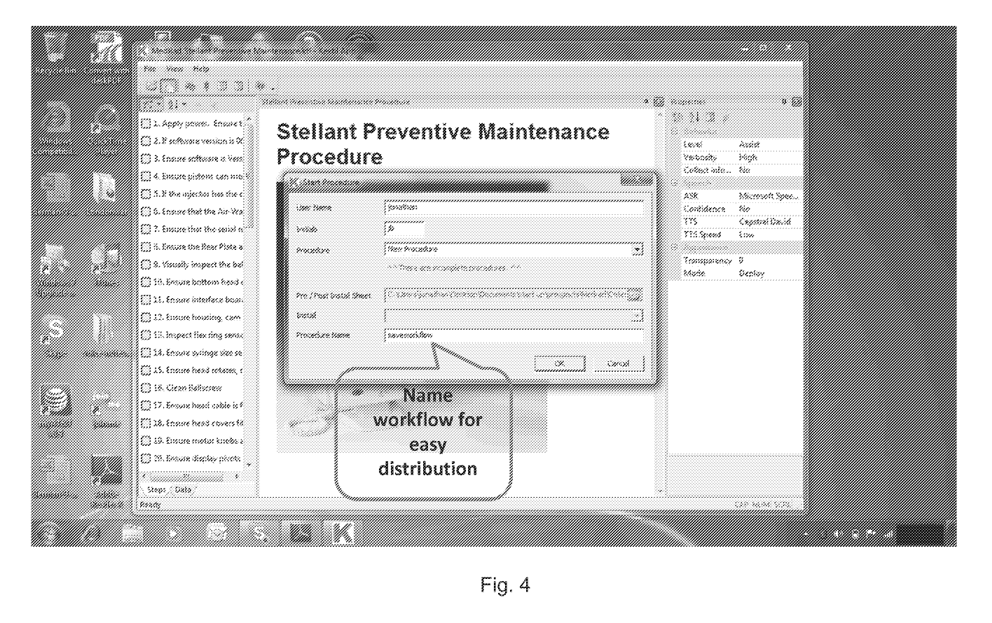

FIG. 4 depicts a step of saving a workflow within the multimodal interface of the present disclosure. A workflow can be named for easy recall and distribution. Modified workflows can be named and saved as different versions.

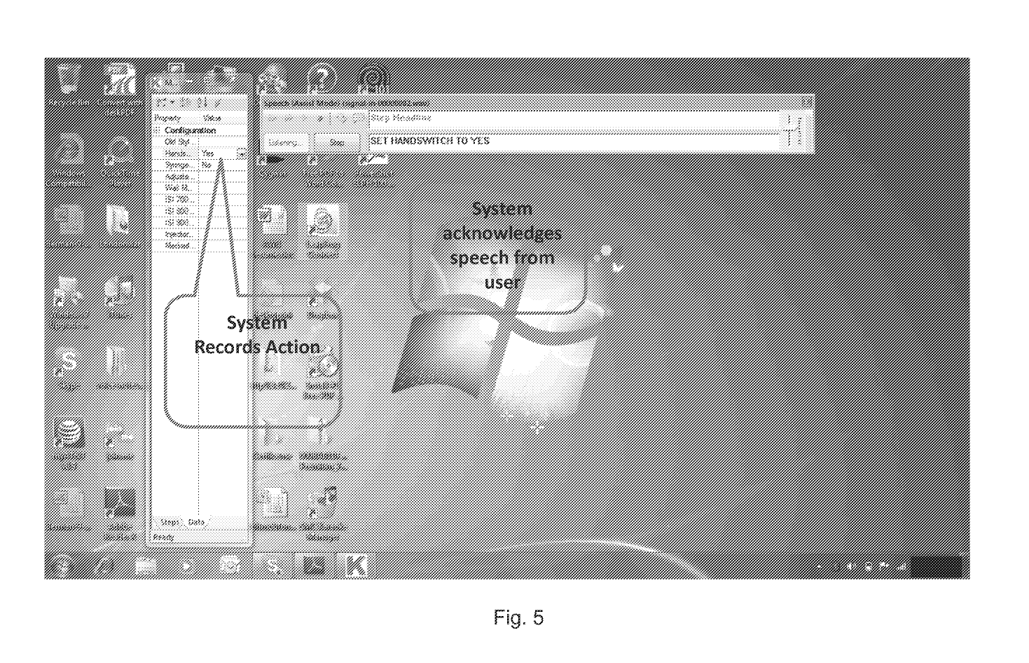

FIG. 5 depicts workflow configuration capabilities within the multimodal interface of the present disclosure. The platform 100 may record user action (in this case configuration) in a separate window (in this case to the left), and the user can either type or enter instructions as to configuration. In this case, the platform 100 recognizes speech from a user stating “SET HANDSWITCH TO YES” and the configuration table is updated by the platform 100 to “yes” in the “handswitch” row of the configuration table in the left window of the screen.

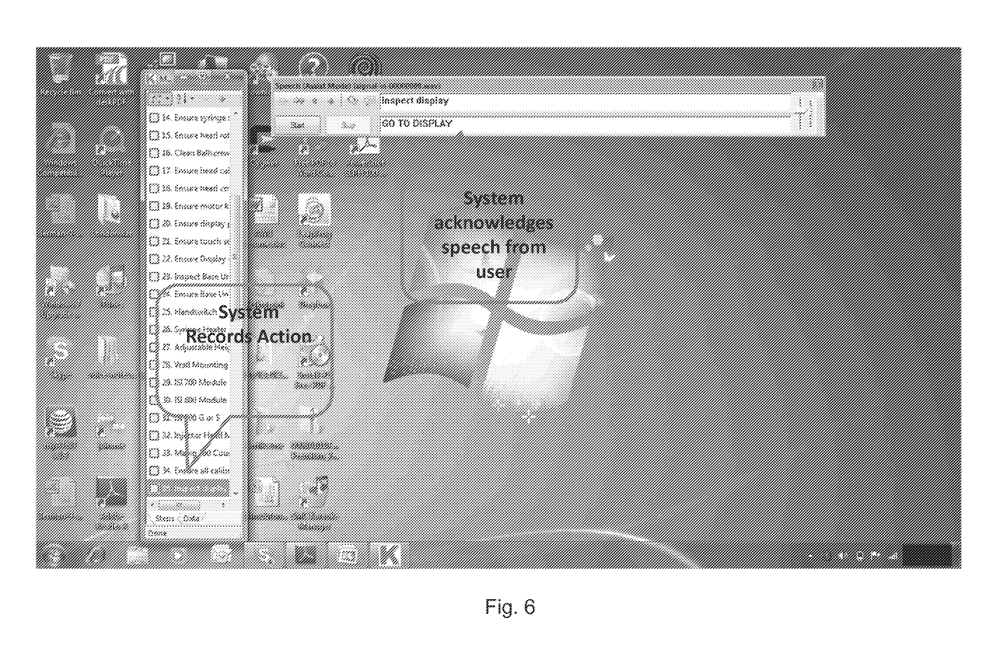

FIG. 6 depicts receiving a voice instruction to go to a step within a workflow within the multimodal interface of the present disclosure. The user speaks “GO TO DISPLAY” which is captured in text on the visual display, prompting the system to take the user to the “inspect display” step, which is step 35 of the workflow depicted in the left window on the screen of FIG. 6. A user can thus navigate to different steps within a workflow using the multimodal interface 102.

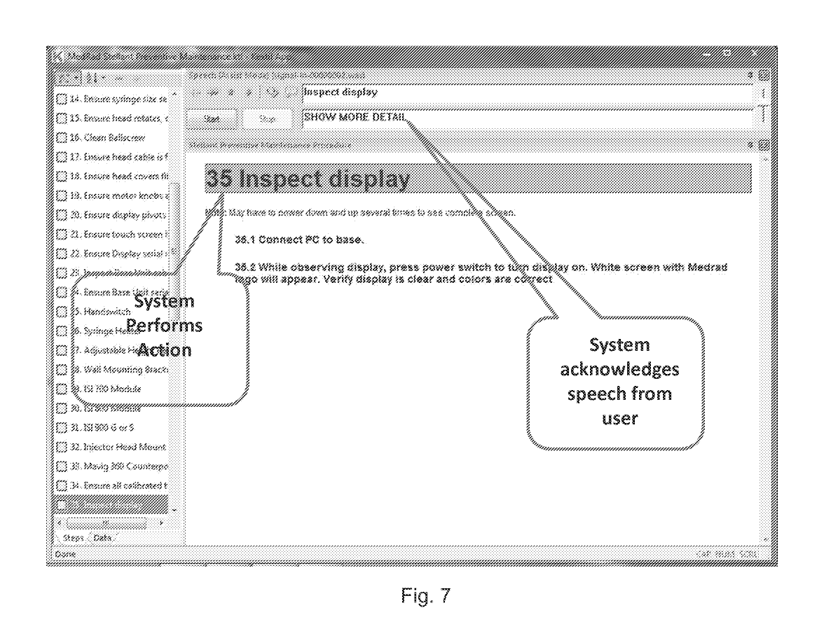

FIG. 7 depicts handling a request for more detail within the multimodal interface of the present disclosure. The user speaks “Show more detail,” in which case the words are captured in the visual display as text and the platform 100 performs an action to show additional detail related to the current step (step 35) relating to the inspection of the display.

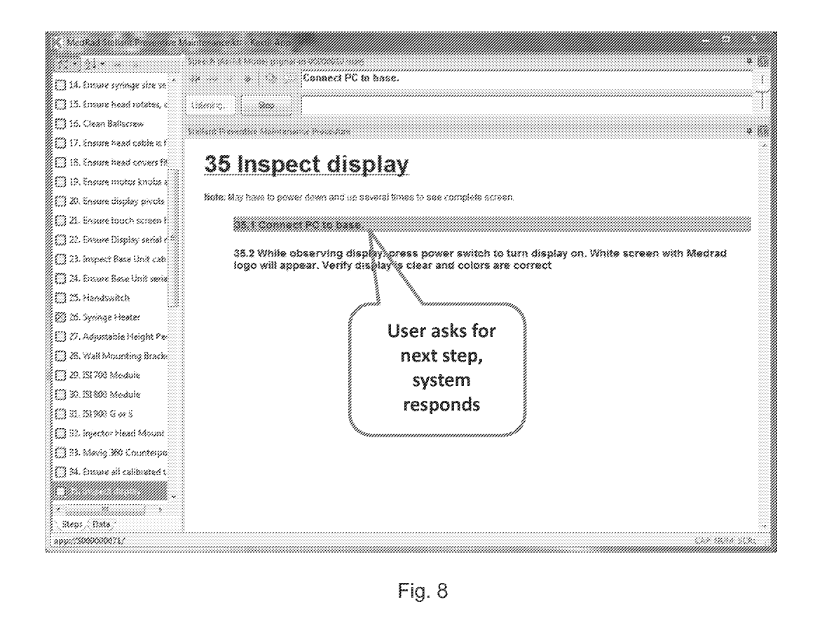

FIG. 8 depicts continuing to a next step of a workflow within the multimodal interface of the present disclosure. In this case the sub-step 35.1, involving connecting a PC to a base, is depicted, along with a related note. Thus the system provides a step-by-step guided workflow.

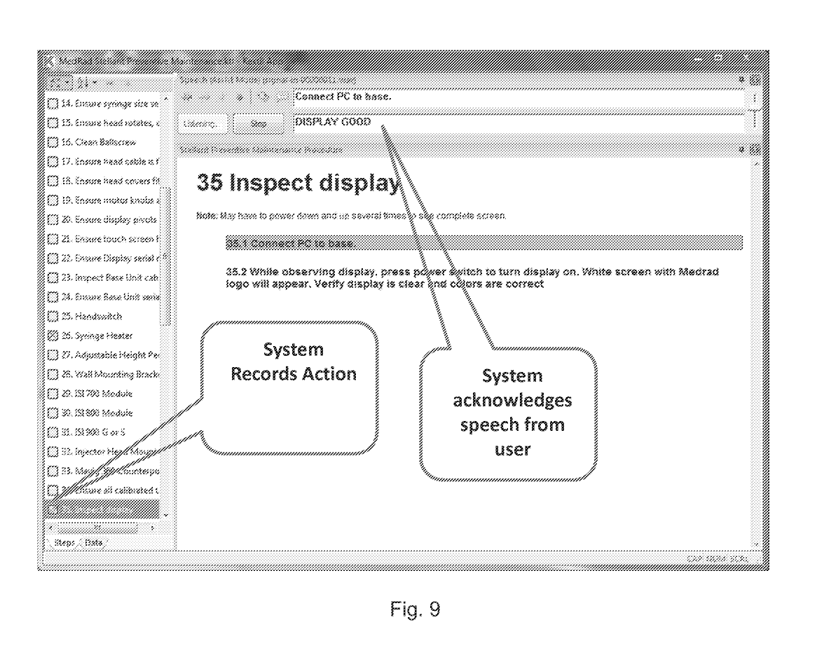

FIG. 9 depicts completion of a step within a workflow within the multimodal interface of the present disclosure. In this case the user speaks “Display Good,” and the platform 100 recognizes this as indicating completion of the inspection of the display. The platform 100 records the completion of the step and proceeds by prompting the user with the next step (or the user may navigate to another step as desired).

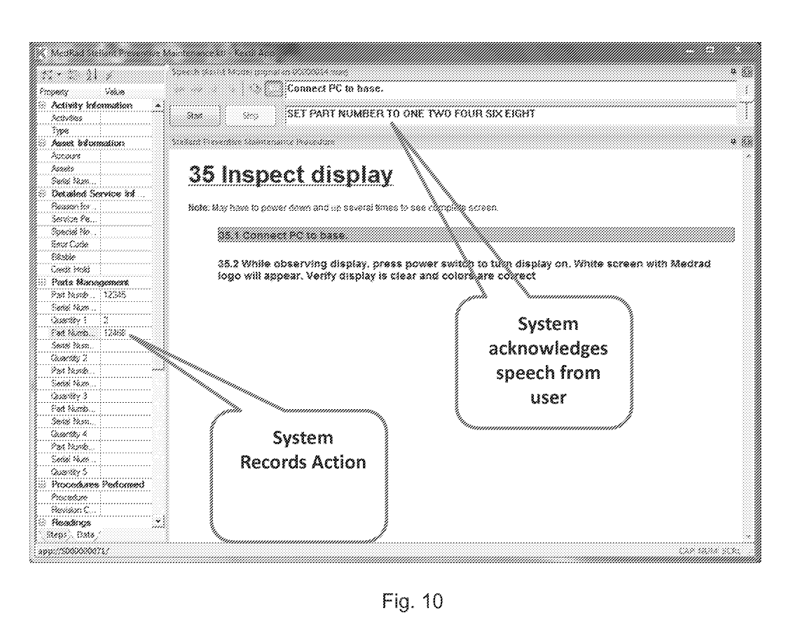

FIG. 10 depicts entering data, a part number, within the multimodal interface of the present disclosure. A user may speak the part number or other data, which is recorded along with the other information captured during completion of the workflow. Thus, the platform 100 may allow rapid, convenient data entry, and the data may be associated with the appropriate step in a procedure, such that it can be retrieved within context later (such as to help understand when and why the user was entering that data in the context of execution of a workflow).

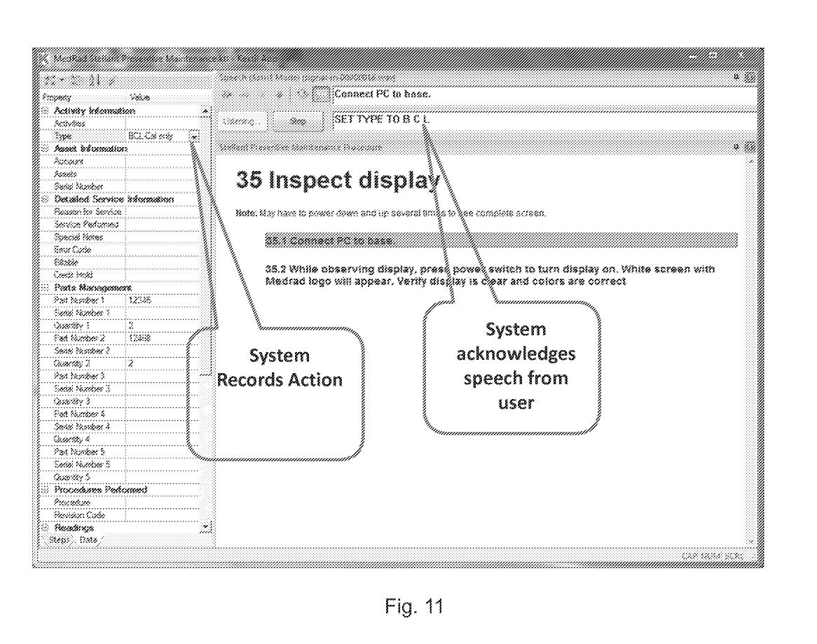

FIG. 11 depicts selection from a pull-down menu within the multimodal interface of the present disclosure. The user can use the visual display to pull down a menu (or speak a prompt for such menu) then speak the appropriate item (in this case “SET TYPE TO B CL”), in which case the system captures the input and selects the menu item, again recording the selection in the context of the current execution of the workflow.

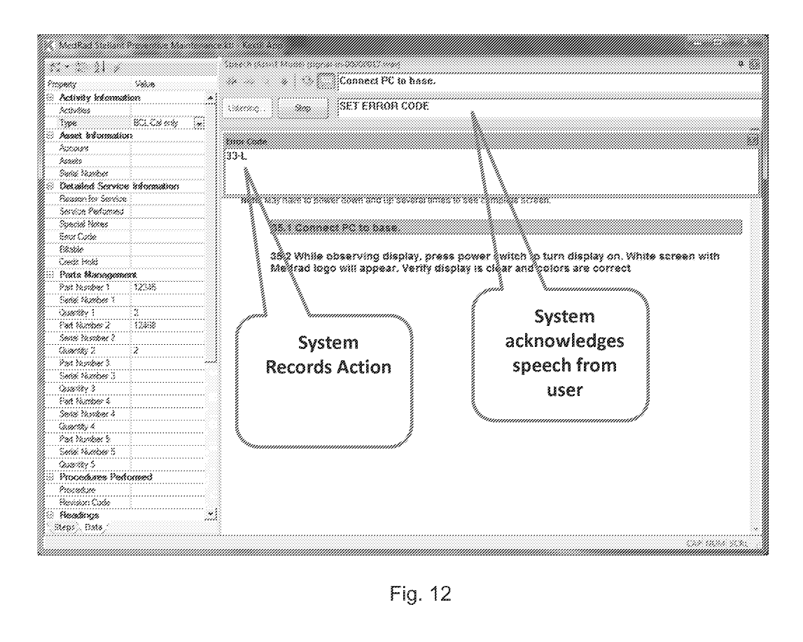

FIG. 12 depicts taking entry via a keyboard within the multimodal interface of the present disclosure. At any point a user may use keyboard entry rather than speech.

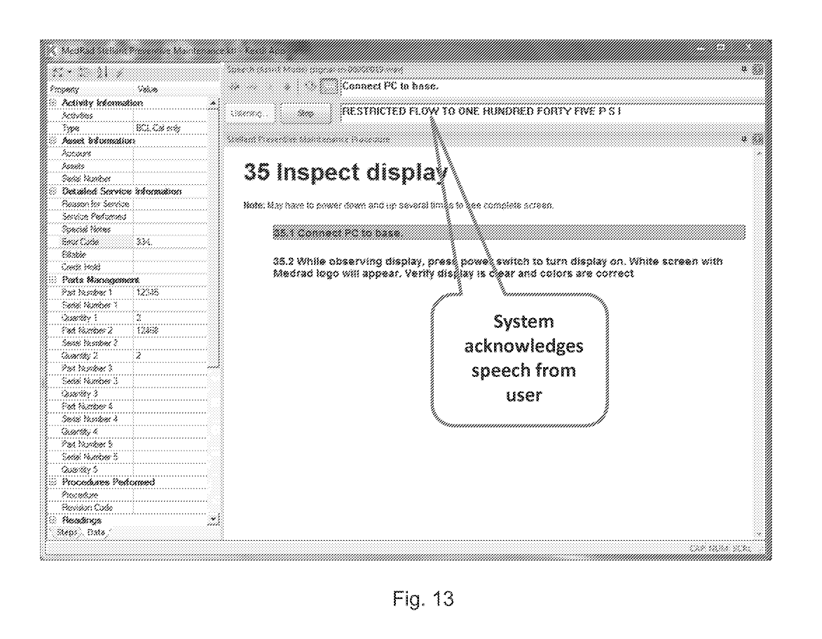

FIG. 13 depicts capturing an action that was undertaken by a user during execution of workflow within the multimodal interface of the present disclosure. In this case the user indicates that it “RESTRICTED FLOW TO ONE HUNDRED FORTY PSI,” an action that is captured by the system and associated with the execution of that particular workflow. The capturing of actions allows, among other things, the use of conditional logic within the plan based dialog manager, such that subsequent steps can be based upon the parameters associated with completion of an action (both whether it was completed, but also data as to how some action was completed, in this case with setting pressure at a particular level).

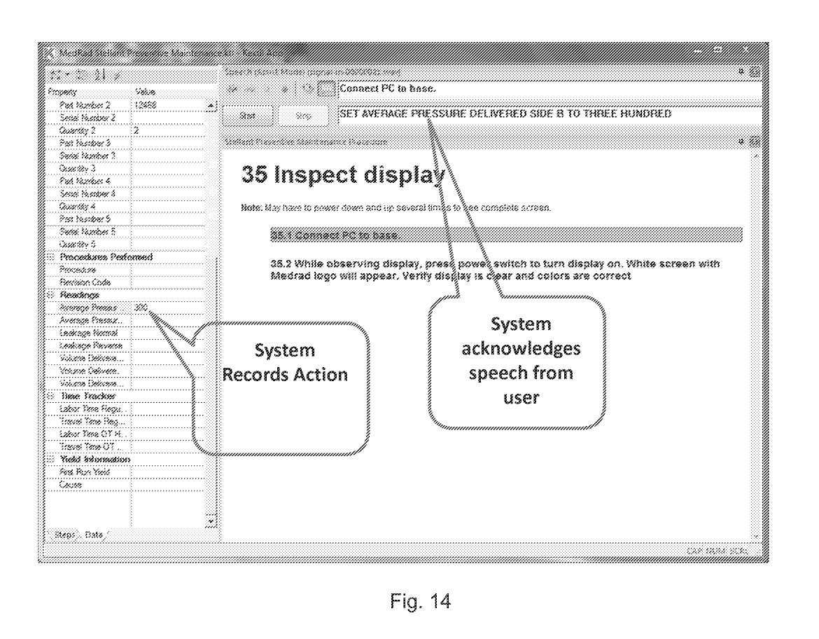

FIG. 14 depicts identifying a data field and capturing data during execution of a workflow within the multimodal interface of the present disclosure. Data may relate to an action completed, a setting or parameter adjusted, or a wide range of other actions.

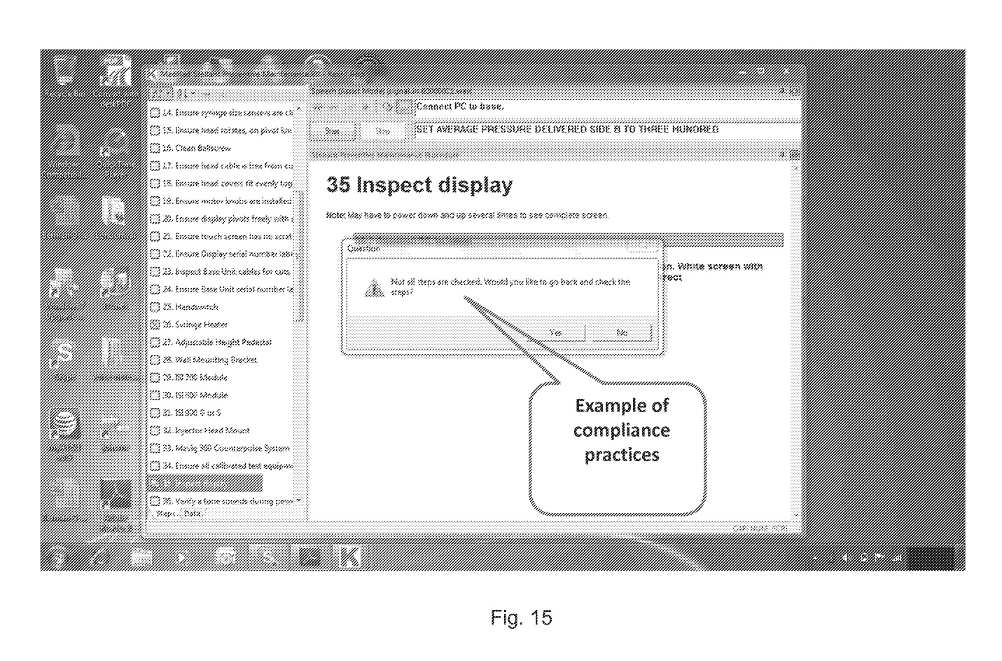

FIG. 15 depicts presenting a message relating to compliance with requirements for a workflow within the multimodal interface of the present disclosure. Thus, the plan based dialog manager 104 may guide a user to comply with the requirements for a workflow, including completing required steps, refraining from undertaking prohibited steps, staying within thresholds for settings and parameters associated with particular steps, and the like. The platform 100 allows guiding in compliance with workflows, as well as recording input data, parameters, and steps completed, to verify compliance with workflow requirements or identify variances from workflow requirements.

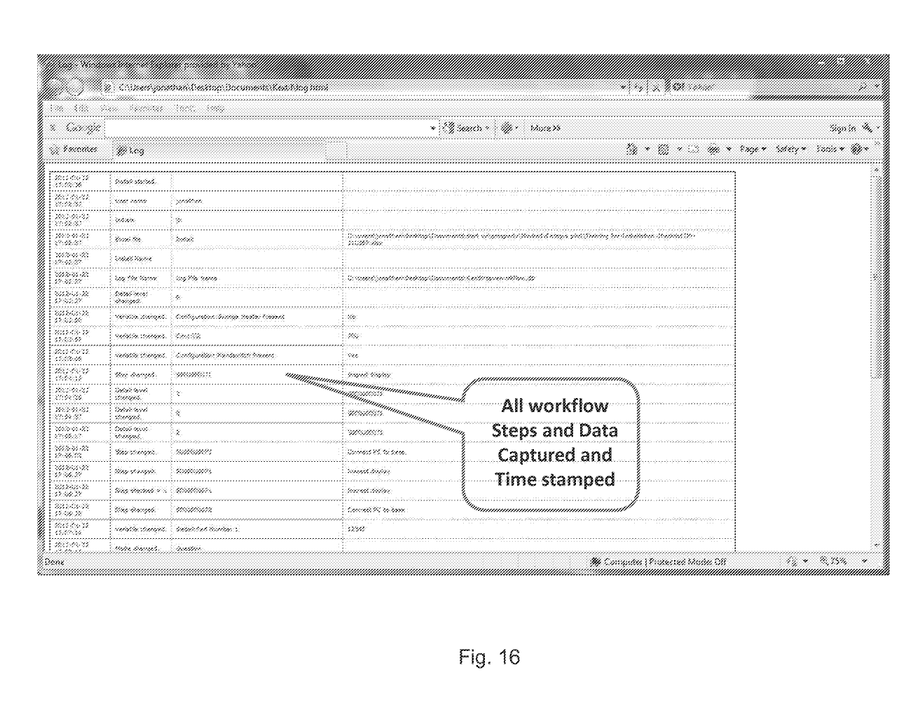

FIG. 16 depicts logging time stamped data relating to steps completed within a workflow within the multimodal interface of the present disclosure. Each step completed, data entered, parameter adjusted, and the like may be captured with a time stamp, providing a complete record for compliance purposes and for analysis, such as for identification of flaws in workflows or ways in which workflows can be improved. Logging also allows a record of activities on particular systems or equipment, so that future users can accurately determine the starting point for future operations.

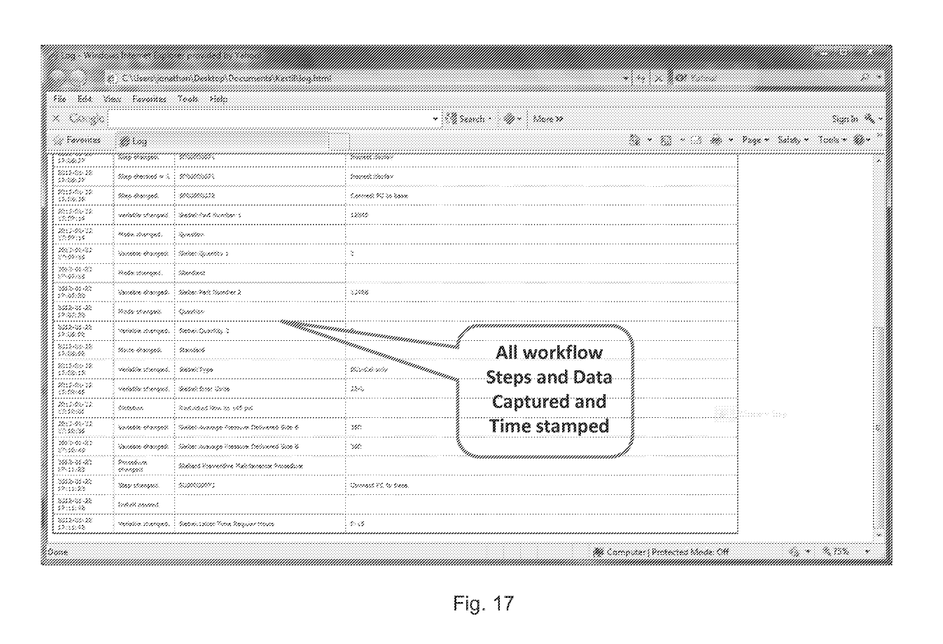

FIG. 17 depicts further details relating to logging time stamped data relating to steps completed within a workflow within the multimodal interface of the present disclosure.

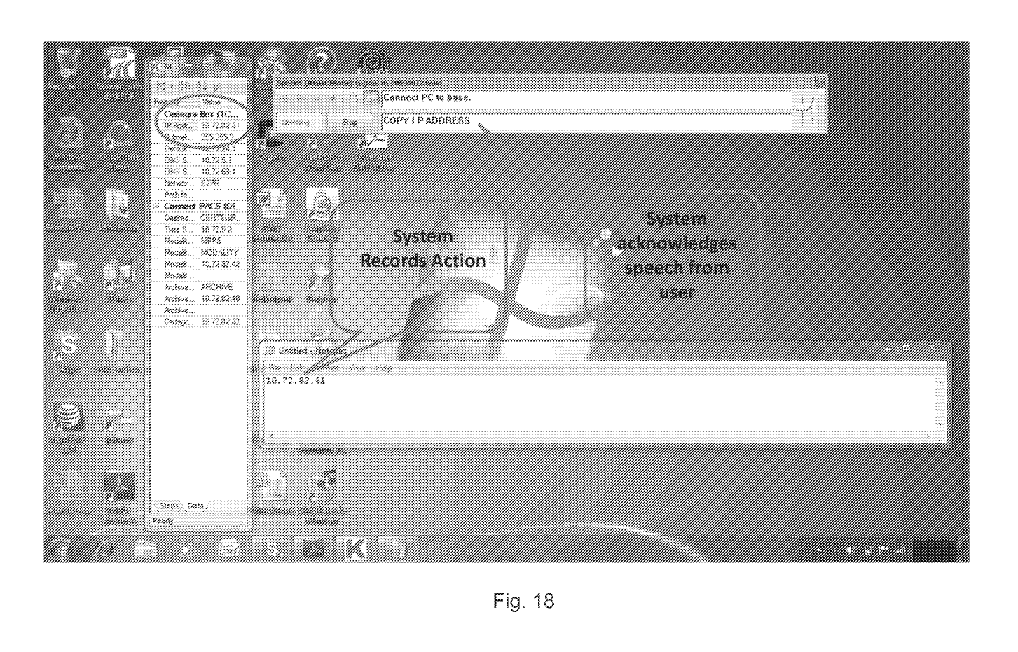

FIG. 18 depicts capture and paste capability within the multimodal interface of the present disclosure. A user may capture/copy data within the interface by keyboard, touch, or speech interaction and paste that data into other fields associated with a workflow (or otherwise within the platform 100).

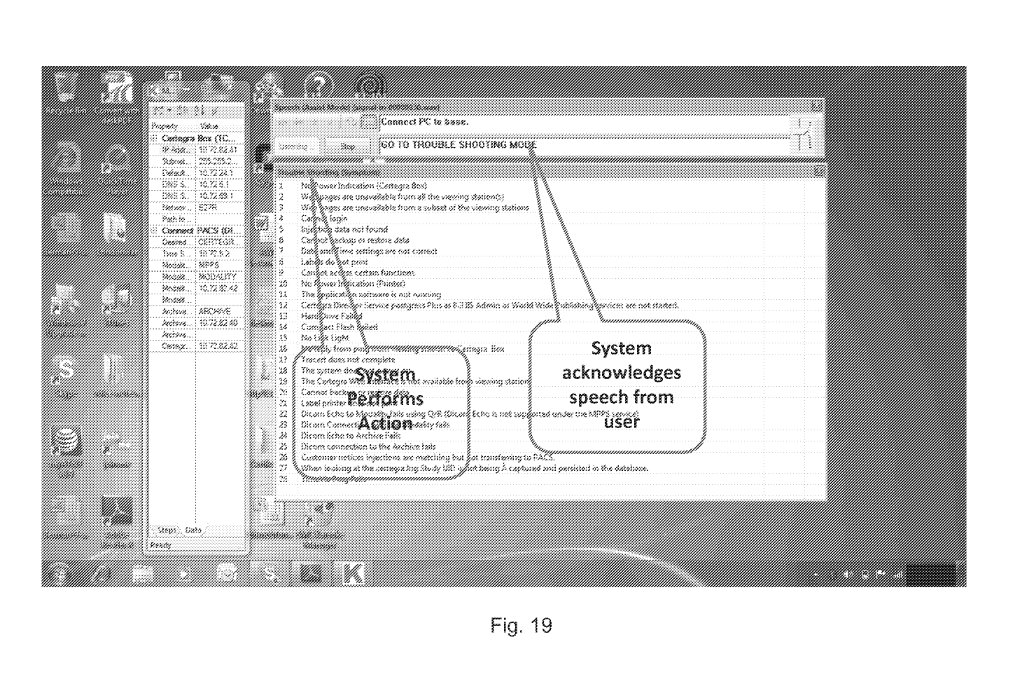

FIG. 19 depicts troubleshooting capability within the multimodal interface of the present disclosure. A user may speak or otherwise enter a command to move into troubleshooting mode, in which case troubleshooting notes and steps for a workflow may be displayed and the user may be guided through troubleshooting for a particular device, step, or the like.

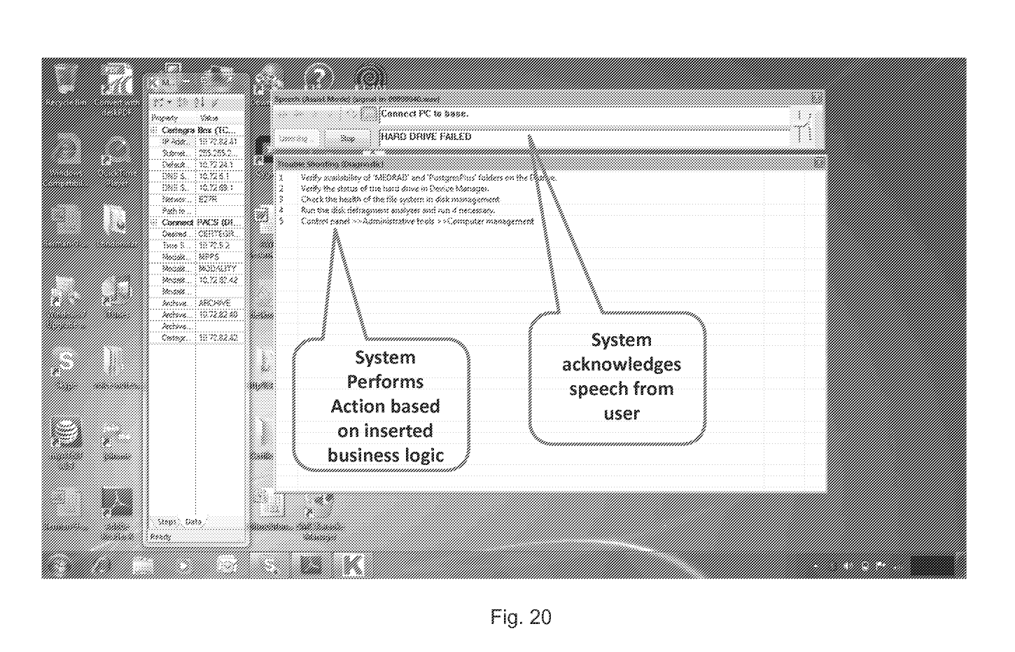

FIG. 20 depicts identification of a problem with execution of a workflow within the multimodal interface of the present disclosure. The system may indicate a problem (in this case failure of a hard drive) that either prevents completion of the workflow or requires a modified workflow, such as involving correction of the problem prior to returning to the original workflow.

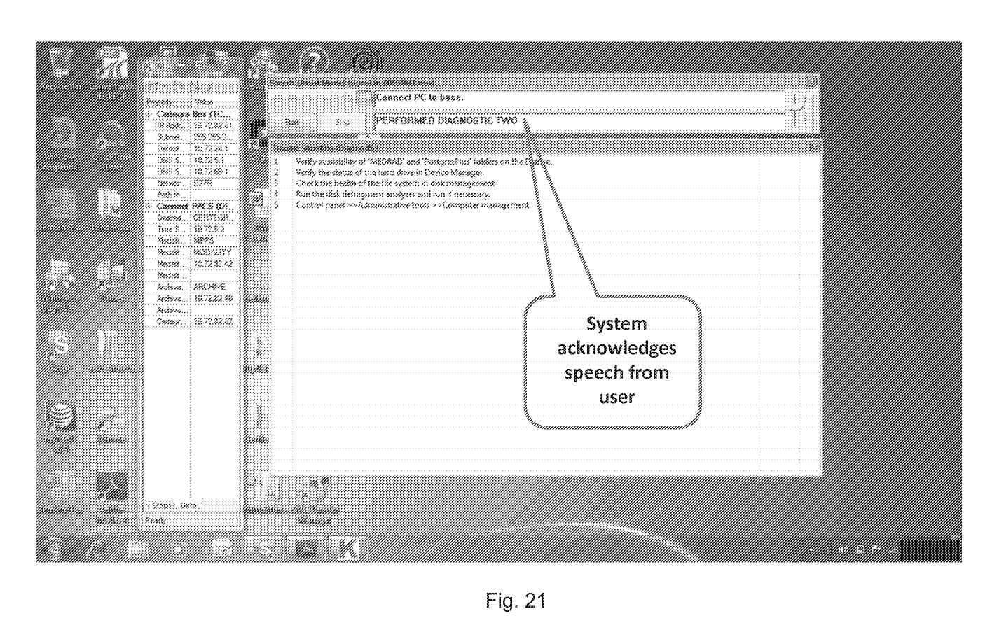

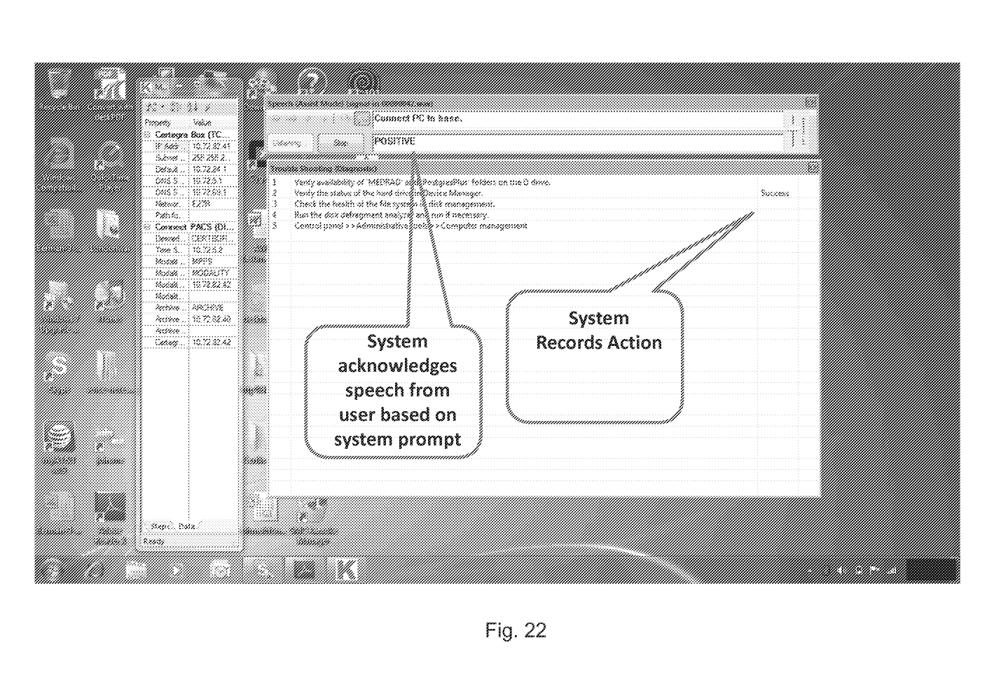

FIG. 21 depicts performing a diagnostic test within the multimodal interface of the present disclosure, and FIG. 22 depicts recording a diagnostic result within the multimodal interface of the present disclosure. In the case of diagnostic testing the platform 100 may record the conducting of the test and the result.

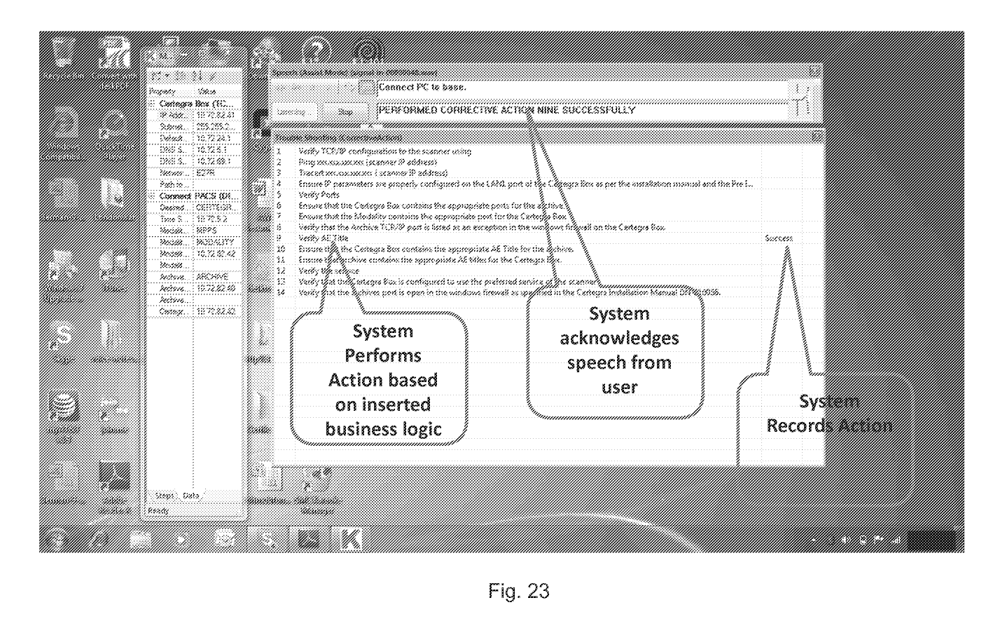

FIG. 23 depicts performing a corrective action and recording a result within the multimodal interface of the present disclosure. In this case, the system may perform certain actions automatically at a point in the workflow based on conditional logic built into the workflow for use by the plan based dialog manager. The system may record both user and system actions as with other steps associated with the workflow described herein.

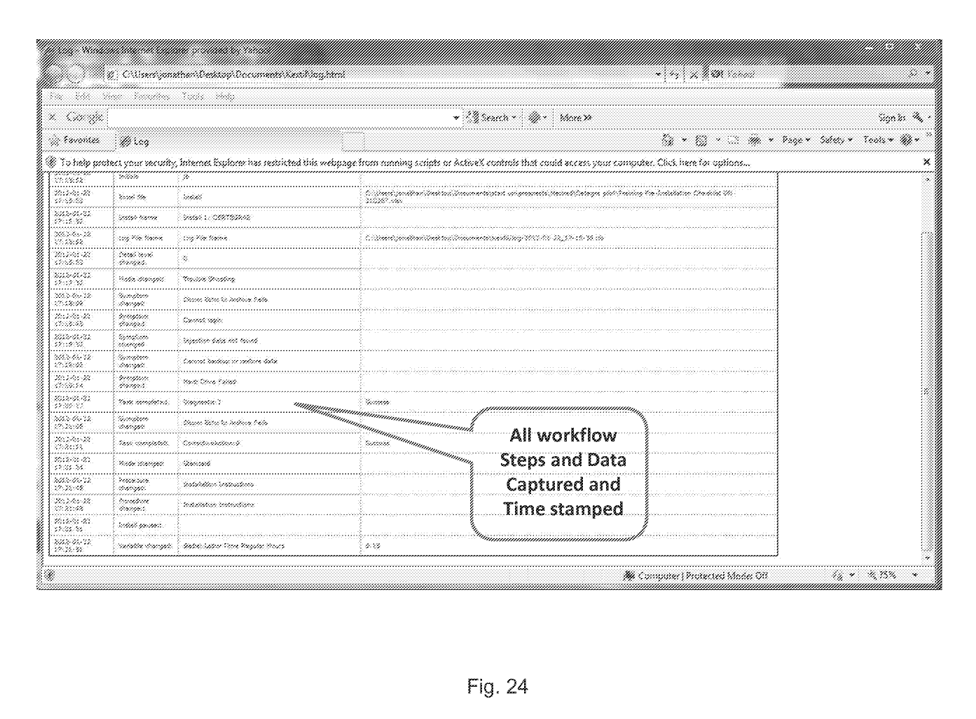

FIG. 24 depicts further details relating to logging time stamped data relating to steps completed within a workflow within the multimodal interface of the present disclosure. Again, all user actions, system-initiated actions, speech (from the user or the system), data entered, and the like, may be captured in a step-by-step, time-stamped fashion and stored in connection with the particular execution of a particular type of workflow, allowing deep analysis of workflows for compliance purposes, for determining the current state of various systems or operations, and for improvement of workflows and/or workers.

In embodiments of the present disclosure the platform 100 may allow a user to search, such as to pull information related to a particular topic. A search may be within a particular workflow, within the platform 100, or within the data sources accessed by the platform. Queries may include finding out whether a particular task will be done within a workflow, finding out what training is required, finding out what prerequisites exist, or a wide range of others.

The present disclosure may be used in connection with field service workflows, such as servicing capital equipment, such as medical devices and systems, imaging systems, health care IT systems, telecommunications infrastructure, manufacturing equipment, vehicles and other transportation equipment, building infrastructure systems (elevators, escalators, HVAC), electronic devices (computer systems, servers, printers, databases, etc.), energy assets (grid infrastructure, alternative energy production, energy transport equipment, and the like) and a wide range of other assets that are regularly serviced by field service technicians. In embodiments such systems may be used to guide other workflows, such as related to asset management, quality, manufacturing, and sales.

The methods and systems disclosed herein may be integrated with other systems, or may provide inputs to or take outputs from other systems, such as through application programming interfaces. These may include enterprise resource planning (ERP) systems, asset tracking systems (e.g., RFID or scanner-based systems), inventory tracking systems, asset management systems, enterprise databases (e.g., inventory and supply chain databases), enterprise service management systems, and the like.

Methods and systems disclosed herein may include a library of applications, applets, or the like, that can be used to create workflows, such as reusable applets for common workflow elements, business logic common to many workflows, vocabulary elements appropriate for particular operations, or the like. Thus, the platform 100 may be access to a wide range of stored data and applications that allow convenient construction of new workflows using previous constituent elements.

In embodiments off the shelf hardware, such as Bluetooth headsets and boom microphones may be used to provide good speech input to the system.

In various preferred embodiments disclosed herein a wide range of product features and user interface capabilities may be enabled, including configurable settings, software customized for particular content, tracking of databases being interfaced with (such as during a workflow, such as a service event), providing information ahead of time to the user, capturing post-completion information (such as a post-install sheet that is completed after user is done, such as indicating how equipment was configured), creation/recreation of forms, pulldown menus, free text entry, retrieving stored procedures, saving and sending a workflow, tracking what was done and not done, providing modes of operation (e.g., standard and troubleshooting), commands (e.g., navigate, show more detail, what is this step?, walk me through it, tell me, copy, slow down, read notes), capturing data, mixed initiative capability (where some steps are user-controlled and other steps are system controlled or initiated in automatic fashion).

In embodiments workflows may be made flexible, using business logic that allows a system to provide a configurable or optimized workflow based on user input, system-initiated optimization, or both.

This illustrative, non-limiting embodiment is a facility for guiding a workflow through a multimodal interface. While described in connection with certain preferred embodiments, other embodiments would be understood by one of ordinary skill in the art and are encompassed herein.

The methods and systems described herein may be deployed in part or in whole through a machine that executes computer software, program codes, and/or instructions on a processor. Embodiments may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While embodiments have been disclosed in connection with the preferred embodiments shown and described in detail, various modifications and improvements thereon will become readily apparent to those skilled in the art. Accordingly, the spirit and scope of the embodiments is not to be limited by the foregoing examples, but is to be understood in the broadest sense allowable by law.

All documents referenced herein are hereby incorporated by reference.

What is claimed is:

1. A method comprising:
transforming textual material data into a multimodal data structure comprising a plurality of classes selected from the group consisting of output, procedural information, and contextual information to produce transformed textual data;
storing the transformed textual data on a memory device;
retrieving, in response to a user request via a multimodal interface, requested transformed textual data; and
presenting the retrieved transformed textual data to the user via the multimodal interface.

2. The method of claim 1 wherein the textual material data comprises installation manual data.

3. The method of claim 1 wherein the multimodal interface is configured to receive and to present data in a plurality of modes selected from the group consisting of audio, textual, and visual.

4. The method of claim 3 wherein presenting the retrieved transformed textual data comprises presenting the retrieved transformed textual data in a mode selected, at least in part, based upon a user defined preference.

5. The method of claim 3 wherein presenting the retrieved transformed textual data comprises presenting the retrieved transformed textual data in a mode selected, at least in part, upon an attribute of retrieved transformed textual data.

6. The method of claim 1 wherein the textual material data comprises a workflow.

7. The method of claim 6 wherein the workflow comprises a plurality of sequential steps.

8. The method of claim 7 further comprising storing information indicative of a completion of one of the plurality of sequential steps.

9. The method of claim 1 wherein the transforming comprises manual transformation.

10. The method of claim 1 wherein the transforming comprises at least one of automated and semi-automated transformation.

11. The method of claim 1 wherein the textual material data comprises preventive maintenance manual data.

12. A computer readable medium containing program instructions wherein execution of the program instructions by one or more processors of a computer system causes the one or more processors to carry out the steps of:
transforming textual material data into a multimodal data structure comprising a plurality of classes selected from the group consisting of output, procedural information, and contextual information to produce transformed textual data;
storing the transformed textual data on a memory device;
retrieving, in response to a user request via a multimodal interface, requested transformed textual data; and
presenting the retrieved transformed textual data to the user via the multimodal interface.

13. The computer readable medium of claim 12 wherein the textual material data comprises installation manual data.

14. The computer readable medium of claim 12 wherein the multimodal interface is configured to receive and to present data in a plurality of modes selected from the group consisting of audio, textual, and visual.

15. The computer readable medium of claim 14 wherein presenting the retrieved transformed textual data comprises presenting the retrieved transformed textual data in a mode selected, at least in part, based upon a user defined preference.

16. The computer readable medium of claim 14 wherein presenting the retrieved transformed textual data comprises presenting the retrieved transformed textual data in a mode selected, at least in part, upon an attribute of retrieved transformed textual data.

17. The computer readable medium of claim 12 wherein the textual material data comprises a workflow.

18. The computer readable medium of claim 17 wherein the workflow comprises a plurality of sequential steps.

19. The computer readable medium of claim 18 further comprising causing the one or more processors to carry out the steps of storing information indicative of a completion of one of the plurality of sequential steps.

20. The computer readable medium of claim 12 wherein the transforming comprises at least one of automated and semi-automated transformation.

21. The computer readable medium of claim 12 wherein the textual material data comprises preventive maintenance manual data.
